(19) United States
(12) Patent Application Publication
(10) Pub. No.: US 2024/0017632 A1
(43) Pub. Date: Jan. 18, 2024

(54) CHARGING PLUG HOLDER FOR DC QUICK-CHARGING CABLE

(71) Applicant: Siemens Aktiengesellschaft, München (DE)

(72) Inventors: Robert Lehmann, Leipzig (DE); Christian Wolff genannt Wohlauf, Berlin (DE); Pierre Wohlgemuth, Grosspösna (DE); Thomas Wiesner, Leipzig (DE)

(21) Appl. No.: 18/251,748

(22) PCT Filed: Oct. 29, 2021
(86) PCT No.: PCT/EP2021/080136

§ 371 Date: May 4, 2023

(30) Foreign Application Priority Data
Nov. 4, 2020 (DE) 10 2020 213 884.2

(51) Int. Cl. B60L 53/30; B60L 53/16

(52) U.S. Cl. CPC B60L 53/30; B60L 53/16

(57) ABSTRACT

A charging device for an electric vehicle is equipped with a housing, power electronics arranged in the housing, a charging cable which is connected to the power electronics, leads out of the housing and has a charging plug on a distal end, and a charging plug holder arranged on the housing. The charging plug has a grip and a contact portion. The charging plug holder is configured to hold the charging plug. Accordingly, the charging plug holder has a first depression, which is dimensioned and shaped to accommodate the contact portion of the charging plug in an insertion direction and to hold the charging plug when the charging device is in a standby state.

### TECHNICAL FIELD

The invention relates to a charging device for an electric vehicle.

### TECHNICAL BACKGROUND

Charging devices for electric vehicles can use different standards to control charging processes. These standards include the Combined Charging System (CCS), which enables DC and AC charging, and CHAdeMO as a pure DC charging standard. DC charging is particularly important for so-called quick charging, in which charging times of less than an hour are achieved. Since high charging powers and therefore also strong currents are transmitted from the charging device to the electric vehicle during quick charging, the charging cable and charging plug are relatively thick or large and correspondingly heavy compared to pure AC charging. A charging plug holder is therefore typically provided on a charging plug holder to hold the charging plug on the charging device while the charging plug and charging device are not used for charging an electric vehicle. Given the weight load on the charging plug holder, charging plug holders are typically provided that have a clip or fork that engages in or on the grip of the charging plug to hold the charging plug.

The object of the invention is to introduce an improved charging device for electric vehicles.

This object is achieved by a charging device according to claim 1. Preferred embodiments of the invention are the subject of the dependent claims.

### SUMMARY OF THE INVENTION

The invention introduces a charging device for DC charging of electric vehicles, which is provided with a housing, power electronics arranged in the housing, a charging cable which is connected to the power electronics and which leads out of the housing and has a charging plug at a distal end, and a charging plug holder arranged on the housing. The charging plug has a grip and a contact portion. The charging plug holder is designed to hold the charging plug. According to the invention, the charging plug holder has a first depression sized and shaped to receive the contact portion of the charging plug in an insertion direction and to hold the charging plug in a standby state of the charging device.

The invention is based on and includes the realization that numerous different charging plugs and charging cable designs are available, but the common charging plug holders are basically adapted to the shaping of the charging plug in its entirety, i.e. in particular also to the shape of the grip of the charging plug. Each manufacturer of charging plugs offers an associated charging plug holder, the shape of which is normally only suitable for the corresponding charging plug, but not for models from other manufacturers. This means that a manufacturer of a charging device has to commit to one supplier for the charging plug, since a mechanical interface adapted to the charging plug holder has to be provided on the housing of the charging device. For example, threaded holes must be provided in a specified number and at specified locations on the housing in order to be able to attach to it a specific charging plug holder for a specific charging plug. However, the specification of a single type and manufacturer entails technical as well as economic disadvantages. As a solution to these problems, the inventors have inventively recognized that a charging plug holder is then suitable for any form of charging plug according to a given charging standard, such as CCS or CHAdeMO, if it holds the charging plug at its standardized contact portion. For this purpose, the charging plug holder of the charging device has a first depression with a design that allows the insertion of the contact portion of the charging plug and, after insertion of the contact portion into the first depression and release of the charging plug, holds it in the charging plug holder.

According to the invention, the charging plug is held by the charging plug holder only at its contact portion and not at its grip. The grip of the charging plug is preferably arranged outside the first depression in the standby state. The contact portion is defined here as the part of the charging plug that is intended for contacting a charging socket of an electric vehicle and the electrical function and external design of which are standardized by the relevant charging standard, i.e. in particular according to the CCS or CHAdeMO standard.

Preferably, the contact portion of the charging plug is held in a frictionally engaged manner by the first depression in the standby state. This can be achieved by the effect of gravity and a twisting of the charging plug in the first depression of the charging plug holder and/or by frictional forces between the surface of the first depression on the one hand and the surface of the contact portion of the charging plug on the other hand.

The first depression particularly preferably tapers along the insertion direction. This simplifies the insertion of the charging plug into the first depression of the charging plug holder and at the same time ensures that the contact portion of the charging plug and the wall of the first depression come into contact with each other after the charging plug has been inserted sufficiently far into the first depression.

For example, the first depression may extend around a center axis running in the insertion direction and may have a bottom surface, through which the center axis passes, and a lateral surface facing the center axis. In this case, the center axis particularly preferably forms an acute angle to a horizontal line and the center axis rises in a direction opposite to the insertion direction. This ensures that the charging plug held by the charging plug holder cannot be pulled out of the charging plug holder against the insertion direction—for example by bending forces of the charging cable. In particular, the acute angle can be smaller than 45°. Preferably, the acute angle is between 10 and 20°, for example 12°.

Particularly preferably, the first depression has an inner shape that corresponds at least approximately to an envelope body of the contact portion of the charging plug. This means that the inner shape of the first depression does not have to have a shape complementary to each depression of the contact portion, thus also simplifying the insertion of the charging plug into the charging plug holder. However, it is advantageous here if the inner shape of the first depression has insertion aids of some kind provided in accordance with the relevant charging standard, such as guide rails.

The charging plug holder may have a second depression surrounding an opening of the first depression, such that at least a portion of the grip of the charging plug in the standby state is disposed in the second depression and spaced from a wall of the second depression. For example, the second depression may be at least approximately funnel-shaped, wherein the portion of the second depression having the smallest cross-sectional area of the second depression is located at the transition to the first depression, while the portion of the second depression having the largest cross-sectional area opens to the surrounding environment of the charging device. The second depression may shield the charging plug grip from environmental influences such as rain or snow, and may also help to suitably center the charging plug during insertion into the charging plug holder. Since in the standby state the charging plug grip is spaced from the wall of the second depression, the second depression can provide space for differently shaped grips of different charging plugs.

Preferably, the charging device has a drainage channel leading from a lowest point of the first depression into a surrounding environment of the charging device. The drainage channel can drain rain and splash water from the first depression into the surrounding environment, so that the charging plug can be stored as dry as possible in the charging plug holder. For example, the drainage channel may be formed as a slot on the bottom of the charging plug holder sloping towards the surrounding environment of the charging device.

The charging plug holder is preferably made of plastic. Plastic is cost-effective and can offer a good compromise between strength and flexibility to withstand the stresses caused by the insertion and removal of the charging plug during operation of the charging device. In this regard, the charging plug holder may be at least partially made of a partially transparent, particularly opalescent, plastic. The partially transparent or opalescent plastic permits, for example, backlighting of the charging plug holder, which is useful for signaling the readiness for operation of the charging device (or, in the case of a charging device having a plurality of charging ports, of the relevant charging port) by colored backlighting (for example, red for not ready for operation and green for ready for operation), in the context of user guidance when carrying out a charging process (lights as an indication of the charging plug to be removed or reinserted into the charging plug holder) or can also be used advantageously in poor ambient light to simplify insertion of the charging plug into the charging plug holder.

### BRIEF DESCRIPTION OF THE FIGURES

The invention will be explained in greater detail below with reference to illustrations of exemplary embodiments, in which:

FIG. 1 shows a partial view of an exemplary embodiment of a charging device according to the invention with a charging plug holder;

FIG. 2 shows a first exemplary embodiment of a charging plug holder in a perspective front view;

FIG. 3 shows a second exemplary embodiment of a charging plug holder in a perspective front view;

FIG. 4 shows the charging plug holder of FIG. 2 in a perspective side view; and

FIG. 5 shows the charging plug holder of FIG. 2 in a perspective rear view.

### DETAILED FIGURE DESCRIPTION

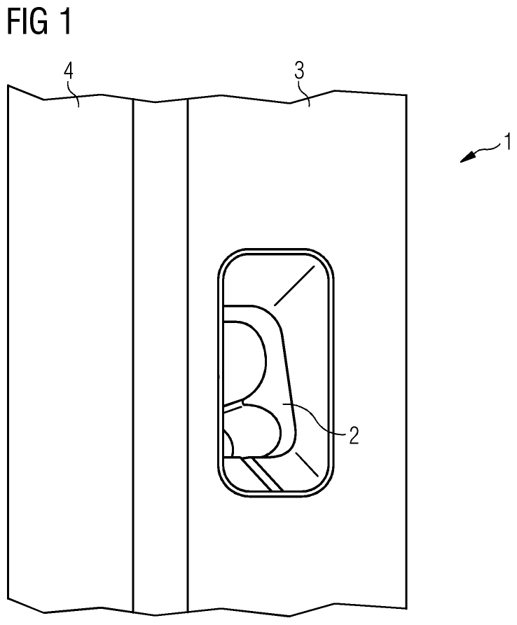

FIG. 1 shows a partial view of an exemplary embodiment of a charging device 1 according to the invention with a charging plug holder 2. In the exemplary embodiment shown, the charging plug holder 2 is arranged in a housing side wall 3 of the charging device 1. For this purpose, the housing side wall 3 has a recess, against which the charging plug holder 2 is screwed from the interior of the charging device 1. On a housing front 4, for example, there can be arranged operating elements for carrying out a charging process, authentication or payment for the energy received.

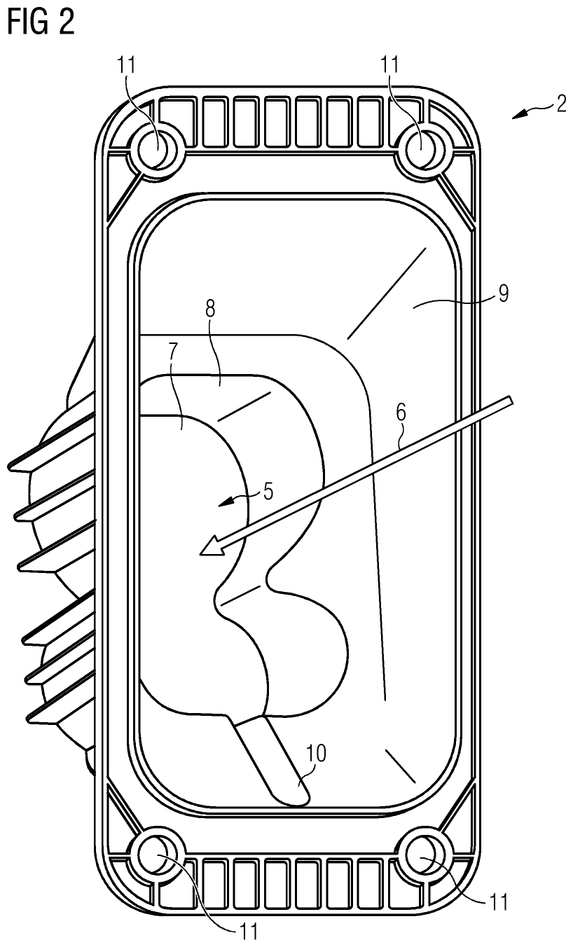

FIG. 2 shows a first exemplary embodiment of a charging plug holder 2 in a perspective front view. The example shown here is designed to accommodate a CCS charging plug. For this purpose, the charging plug holder 2 has a first depression 5, the shape of which corresponds approximately to an envelope body of the contact portion of a standard CCS charging plug. The contact portion of a CCS charging plug can be inserted into the first depression 5 along an insertion direction 6, which is drawn on a center axis of the first depression in FIG. 2. After the charging plug has been released, the charging plug holder 2 holds the charging plug at its contact portion until the charging plug is removed again from the charging plug holder 2 for another charging process of an electric vehicle.

The charging plug can be inserted into the charging plug holder 2 until the contact portion of the charging plug meets a bottom surface 7 of the first depression 5. A lateral surface 8 of the first depression 5 tapers along the insertion direction, so that the contact portion of the charging plug, which is designed with outer boundaries that are substantially parallel to each other, comes into physical contact with the lateral surface 8 during the insertion movement, and the frictional forces exerted by the lateral surface 8 on the contact portion increase with the insertion depth of the contact portion into the first depression 5.

The charging plug holder 2 additionally comprises a second depression 9, which has a larger volume than the first depression 5 and extends in a funnel shape around the opening of the first depression 5. The second depression 9 protects the grip of the charging plug from environmental influences such as rain or snow, and at the same time ensures that the first depression 5 is located further behind the housing side wall 3 of the charging device 1 so that the free contact ends of the contact portion of the charging plug are better protected from environmental influences.

In order to drain off water entering the charging plug holder 2 and, in particular, its first depression 5 from the outside, the charging plug holder 2 has a drainage channel 10 which, in the present case, is embodied as a gap which is open towards the space enclosed by the charging plug holder 2 and which slopes downwards from the lowest point of the first depression 5 towards a surrounding environment of the charging device 1.

The charging plug holder 2 of FIG. 2 has, by way of example, only four feedthroughs 11, through which screws or similarly acting fastening means can be passed in order to fasten the charging plug holder 2 to the housing of the charging device 1. This is preferably done from the interior of the charging device 1 so that a stepless surface is obtained, which has advantages with respect to the tightness of the charging device 1 against penetrating moisture, since water and ice are less likely to adhere to the surface of the charging device.

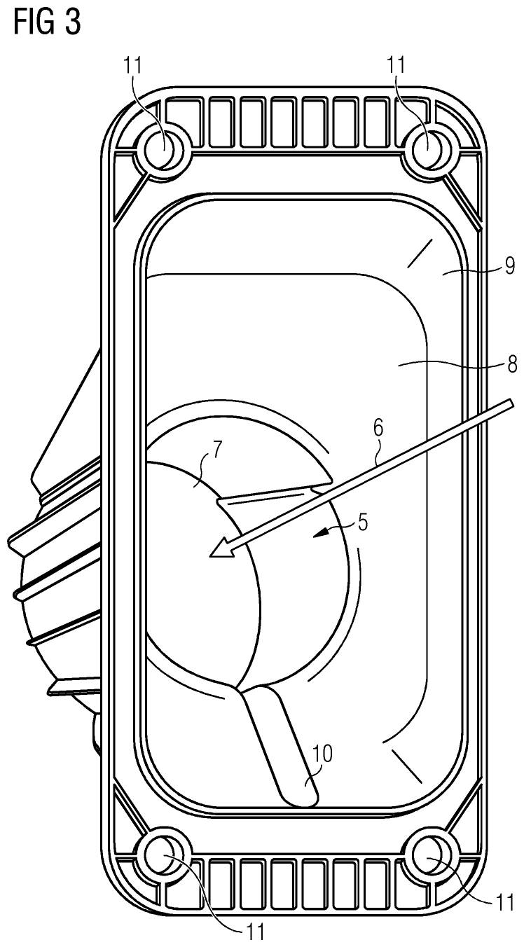

FIG. 3 shows a second exemplary embodiment of a charging plug holder 2 in a perspective front view. The second exemplary embodiment largely corresponds to the first embodiment of FIG. 2, but the shape of the first depression 5 is adapted in the present case to a CHAdeMO charging plug. What has been said for the first exemplary embodiment otherwise applies correspondingly for the second exemplary embodiment.

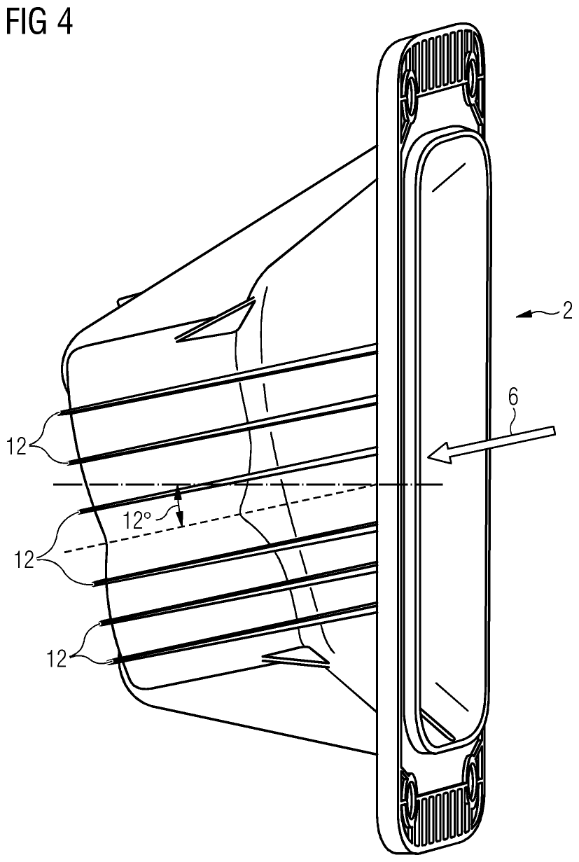

FIG. 4 shows the charging plug holder 2 of FIG. 2 in a perspective side view. In the side view, it can be seen that the insertion direction 6 oriented along the center axis of the first depression slopes downwards toward the first depression or rises away from the charging plug holder of the charging device. As shown in FIG. 4, the insertion direction 6 forms an angle here of 12° to the horizontal in the example shown. Angles deviating from this value can of course be provided, but they should be smaller than 45° so as not to make it difficult to insert the charging plug into the charging plug holder.

In the perspective side view of FIG. 4, parts of the rear side of the charging plug holder 2 can be seen, the rear side facing the inside of the charging device and therefore not being visible when the charging plug holder is mounted in the charging device. The charging plug 2 of this exemplary embodiment is made of plastic and, to increase stability, is provided with a plurality of transverse ribs 12, which run along the rear side of the charging plug holder 2. In the example shown, the transverse ribs 12 run parallel to the insertion direction 6 or the center axis of the first depression, but other orientations are also possible. Numerous solutions that combine high stability with low material costs are available for this in the field of production of injection-molded parts.

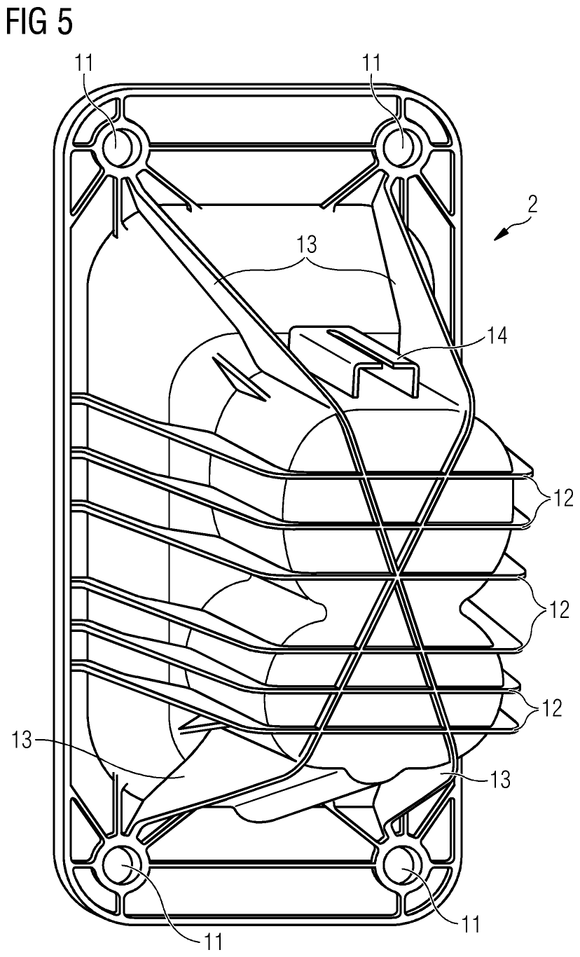

FIG. 5 shows the charging plug holder 2 of FIG. 2 in a perspective rear view. In this view, the transverse ribs 12 mentioned for FIG. 4 are particularly clearly visible. In addition, the charging plug holder 2 has longitudinal ribs 13 which run diagonally from each bushing 11 to an opposite bushing 11 and increase stability against torsion. Furthermore, it can be seen that the bushings 11 are stabilized by the structure of the rear side of the charging plug holder 2 in the vicinity of the bushings 11. This is advantageous because the charging plug holder 2 is connected to the housing side wall 3 of the charging device 1 at the feedthroughs 11, so that a high load is applied to the charging plug holder 2 at these points when the charging plug is inserted into the charging plug holder 2.

The charging plug holder 2 of FIG. 5 also has a sensor holder 14 that can be used to receive a capacitive sensor. The capacitive sensor can be used to detect the presence or absence of a charging plug inserted into the charging plug holder 2. In this way, the charging device 1 can detect whether or not the charging plug is in the charging plug holder, and can accordingly guide the user by instructions or signals to remove the charging plug for charging an electric vehicle or to reinsert the charging plug into the charging plug holder after charging and before driving away. An embodiment of a charging device according to the invention with a charging plug holder which has a sensor holder and/or a capacitive sensor arranged on the charging plug holder with the described functionality therefore represents a further advantageous embodiment of the present invention.

The invention has been explained in greater detail with the aid of illustrations of exemplary embodiments. The examples shown are merely intended to provide a better understanding of the invention and not to limit it as defined exclusively by the following patent claims.

### LIST OF REFERENCE SIGNS

1 charging device
2 charging plug holder
3 housing side wall
4 housing front
5 first depression
6 insertion direction
7 bottom surface
8 lateral surface
9 second depression
10 drainage channel
11 feedthrough
12 transverse rib
13 longitudinal rib
14 sensor holder

1-10. (canceled)

11. A charging device for DC charging of electric vehicles, the charging device comprising:
a housing;
power electronics disposed in said housing;
a charging cable connected to said power electronics and leading out of said housing, said charging cable having a charging plug at a distal end, said charging plug having a grip portion and a contact portion; and
a charging plug holder disposed on said housing and is configured to hold said charging plug, said charging plug holder having a first depression formed therein and sized and shaped to receive said contact portion of said charging plug in an insertion direction and to hold said charging plug in a standby state of the charging device.

12. The charging device according to claim 11, wherein said grip portion of said charging plug is disposed outside of said first depression in the standby state.

13. The charging device according to claim 11, wherein said contact portion of said charging plug is held in a frictionally engaged manner by said first depression in the standby state.

14. The charging device according to claim 11, wherein said first depression tapers along the insertion direction.

15. The charging device according to claim 11, wherein said first depression extends around a center axis running in the insertion direction and is defined by a bottom surface, through which the center axis passes, and a lateral surface facing the center axis.

16. The charging device according to claim 15, wherein the center axis forms an acute angle to a horizontal line and the center axis rises in a direction opposite to the insertion direction.

17. The charging device according to claim 11, wherein said first depression has an inner shape that corresponds at least approximately to an envelope body of said contact portion of said charging plug.

18. The charging device according to claim 11, wherein said charging plug holder has a second depression formed therein and surrounds an opening of said first depression, such that at least a portion of said grip portion of said charging plug in the standby state is disposed in said second depression and spaced from a wall of said charging plug holder defining said second depression.

19. The charging device according to claim 11, wherein said charge plug holder has a drainage channel formed therein and leading from a lowest point of said first depression into a surrounding environment of the charging device.

20. The charging device according to claim 11, wherein said charging plug holder is at least partially made of a partially transparent plastic.

21. The charging device according to claim 20, wherein said partially transparent plastic is an opalescent, plastic.
